(19) United States
(12) Patent Application Publication
(10) Pub. No.: US 2017/0007486 A1
(43) Pub. Date: Jan. 12, 2017

(54) Device for Therapy and Training for the Back

(71) Applicant: NEW BALLS TRAINING CONCEPTS GMBH, Dorsten (DE)

(72) Inventor: Tetyana Kühne, Bochum (DE)

(21) Appl. No.: 14/916,788

(22) PCT Filed: Sep. 5, 2014
(86) PCT No.: PCT/DE2014/100322

§ 371 Date: May 30, 2016

(30) Foreign Application Priority Data
Sep. 6, 2013 (DE) 20 2013 104 026.6

(51) Int. Cl. A61H 1/00; A63B 21/02; A63B 23/02

(52) U.S. Cl. CPC A61H 1/008; A63B 23/0233; A63B 21/023; A63B 21/02; A61H 2205/081

(57) ABSTRACT

The invention relates to a device for therapy and training for the back, comprising two elastically deformable bodies (1) which are arranged at a distance from each other, between which a deformable spacer (2) which interconnects both bodies (1) is arranged, said device being characterized in that said spacer (2) is embodied as a spring element in form of a helical spring (2), the ends thereof being bent so as to form journals (2.1) extending in the extension of the helical spring axis, said journals being introduced into blocks (3) fixed in the inside of the bodies (1).

The invention relates to a device for therapy and training, comprising two elastically deformable bodies which are arranged at a distance from each other and between which a deformable spacer which interconnects the two bodies to each other is arranged.

A training device described in DE 33 12 060 A1 comprises two massage rolls which are supported to be displaceable along an axis and which are pre-tensioned outwardly or pressed outwardly by a spring arranged on the axis between the massage rolls. The axis is supported by a frame which restricts the outward movement of the massage rolls.

A therapy and training device described in DE 20 2012 104 883 U1 comprises two rotationally symmetrical, elastically deformable bodies which are connected with each other by an axis directly adjoining the two bodies and made of the material of these bodies and are housed in an envelope of flexible material. This envelope is provided in its middle region between the two bodies with a constriction having a smaller cross section than the cross section of the bodies. A spacer made also of flexible or elastically deformable material is placed around the constriction. This spacer ensures functionally similar to a joint that the two rotationally symmetrical bodies are flexibly moveable in the longitudinal direction as well as in the transverse direction appropriately for use.

US 2012/0077648 A1 describes an exercise device for the hand. This exercise device comprises two spherical weight members, preferably consisting of elastomeric material. These members are fastened to the ends of an elongate spring element on which a handle is situated centrally. After having gripped the handle, the weight members can be pivoted back and forth for exercising the hand and arm muscles. This known device is not suited for use as a therapy and training device for the back primarily due to the very large distance between the weight members and the handle.

U.S. Pat. No. 2,691,978 describes a massage device for the chin or chin region comprising two substantially spherical massage bodies which are fastened to an essentially bow-shaped, elastically deformable handle.

JP 000H11332955 A describes an exercising device with two spherical bodies connected to each other by an axis. A spring element is supported on the axis in order to push the two spherical bodies outwardly. This device is designed as an exercising device for the fingers.

U.S. Pat. No. 5,580,336 describes an exercising device to be used for exercising the hand. This device comprises two spherical bodies which are fastened to the ends of an axis. Each spherical body has a diameter of approximately 40 mm in order to be easily held in one hand. The length of the axis connecting the two spherical bodies with each other is designed such that the whole exercising device comprised of the two spherical bodies and the axis can fit into an open hand. The axis connecting the two spherical balls to each other has preferably a length of approximately 75 mm. The two spherical bodies consist of a soft elastic material. The axis is an elongate tube body on which the two spherical bodies can be shifted without being loaded by a spring. The axis is composed of two tube bodies which are provided with end stops and between which an intermediate member forming a joint is located.

It is an object of the invention to design a therapy and training device for the back such that, on the one hand, an appropriate training-related adaption of the device to the back of a person lying on the training device is ensured and that, on the other hand, the stability of the device is improved in particular compared to the back therapy device according to DE 20 2011 104 883 U1.

To solve this problem, the therapy and training device according to the invention, comprising two elastically deformable bodies which are arranged at a distance to each other and between which a deformable spacer connecting the two bodies to each other is mounted, is characterized in that the two elastically deformable bodies each form a separate unit and in that the spacer is embodied as a spring element.

According to a preferred embodiment the ends of the helical spring are bent so as to form pins positioned on an extension of the helical spring axis and introduced preferably into blocks fixed in the interior of the two bodies. The blocks preferable consist of metal, especially steel, or plastic material.

The blocks have a diameter of 27-33 mm, preferably 29-31 mm, and a height of 18-22 mm, preferably 19-21 mm.

According to a further preferred embodiment of the invention, on the outside surfaces of the two in particular rotationally symmetrical bodies elongated grooves are arranged which are extending substantially parallel to the helical spring axis.

The invention will be described in the following with the aid of the drawing in more detail:

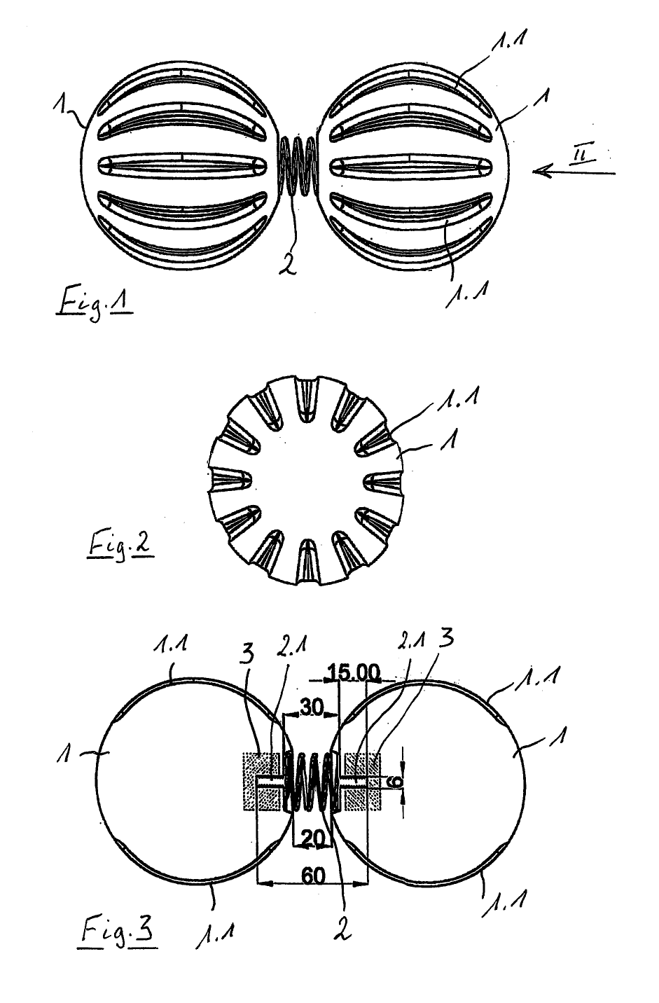

FIG. 1 shows a side view of the therapy and training device according to the invention;

FIG. 2 shows a view in the direction of the arrow II in FIG. 1;

FIG. 3 shows a section view in a schematic representation.

The therapy or training device comprises two preferably rotationally symmetrical, especially spherical bodies 1 having a diameter between 50 mm and 140 mm and consisting especially of foamed material. Between the two bodies 1, a deformable spacer connecting the two bodies 1 with each other is arranged and is embodied as a spring element, preferably a helical spring 2. The ends of the helical spring 2 are bent to form pins 2.1 positioned on an extension of the helical spring axis and introduced or fastened into blocks 3 which are fixed in the interior of the bodies. The blocks 3 have preferably a diameter which is matched to the outer diameter of the helical spring 2 in a range of magnitude of 27-33 mm, preferably 29-31 mm, as well as a height of 18-22 mm, preferably 19-21 mm.

The bodies 1 have preferably such a hardness or stiffness that in use they deform by between 20% and 40% of their diameter.

The bodies 1 are provided at their outer surfaces with curved grooves or recesses 1.1 which are arranged parallel to the helical spring axis.

The blocks consists preferably of metal, especially steel, or of plastic material.

What is claimed is:

1.-8. (canceled)

9. A therapy and training device for the back, the device comprising:
two elastically deformable bodies;
a deformable spacer connecting the two bodies to each other such that the two bodies are spaced at a distance from each other, wherein the deformable spacer is a spring element;
the two bodies having such a hardness or stiffness that, when loaded by a back of a person using the device, the two bodies deform by between 20% and 40% of a diameter of the two bodies.

10. The device according to claim 9, wherein the spring element is a helical spring comprising opposed ends that are bent so as to form pins aligned with a helical spring axis of the helical spring and pointing away from each other.

11. The device according to claim 10, wherein the two bodies each comprise a block arranged and fixed in an interior of the bodies, respectively, wherein the pins are introduced into the blocks.

12. The device according to claim 11, wherein the blocks are comprised of metal.

13. The device according to claim 12, wherein the metal is steel.

14. The device according to claim 11, wherein the blocks are comprised of plastic material.

15. The device according to claim 11, wherein the blocks have a diameter of 27 mm-33 mm and a height of 18 mm-22 mm.

16. The device according to claim 15, wherein the blocks have a diameter of 29 mm-31 mm and a height of 19 mm-21 mm.

17. The device according to claim 9, wherein the spring element is a helical spring and wherein the bodies comprise outer surfaces that are provided with curved grooves or recesses, wherein the curved grooves or recesses extend parallel to a helical spring axis of the helical spring.
